(19) United States
(12) Patent Application Publication
(10) Pub. No.: US 2008/0023234 A1
(43) Pub. Date: Jan. 31, 2008

(54) Self controlled, electric powered trailer

(76) Inventor: Linghsiao Jerry Wang, Irvine, CA (US)

Correspondence Address: LINGHSIAO JERRY WANG, 10 MINERS TRAIL, IRVINE, CA, 92620, US

(21) Appl. No.: 11/460,596

(22) Filed: Jul. 27, 2006

(51) Int. Cl. B62D 59/04

(52) U.S. Cl. 180/14.2; 280/204

(57) ABSTRACT

A two wheeled trailer is attached to a human powered vehicle such as a bicycle or a scooter for carrying load such as children. The trailer is powered by two electric motors and at least one battery. The control of the motor is through a force/pressure meter inserted to the attachment arm between the two wheel vehicle and the trailer. The attachment arm, on the vehicle side is mounted near the rear axle of the vehicle. A coupler that allows free rotation attaches the trailer to the vehicle.

### BACKGROUND OF THE INVENTION

A. Filed of the Invention

The present invention pertains generally to electric vehicles and specifically to an electric powered trailer that propel itself so as to minimize the pulling effort from the attached vehicle.

B. Description of the Background

Traditionally, human muscle power has propelled bicycles and push scooters by way of pedaling or pushing. Attached with trailer to carry load such as children or canoe requires more muscle power, as well as reduce speed, limiting the performance of the bicycle or push scooter. Various types of motors have been mounted on bicycles and push scooters. However, the motor power is not always needed if the trailer is not attached. In addition, using the motor power to propel the bicycle completely defeats the purpose of recreation. Existing powered trailers are made to actually push the bicycle or scooter instead of offload the effort. The power of those trailers is controlled by the rider for that purpose. A trailer that can automatically adjust its power to keep up with the bicycle or scooter makes the leisure riding with kids in the trailer more enjoyable while keeping all the riding fun.

A prior invention by John Bidwell described a trailer with electric powered motor that is controlled by a potentiometer on the rider's handle bar. As described earlier, the design is good if to propel the attached vehicle is the main purpose. Leisure recreational riding tends to go on varying speed, hence makes active adjustment of power output needed. That keeps user busy on tuning the power level.

It would therefore be valuable to provide a method of fully automatic control for the powered trailer that requires minimum rider intervention, had large carrying capacity while still being stable, was easily detachable, and did not provide unwanted forces onto the bicycle or scooter that were unnatural or difficult for the operator.

### SUMMARY OF THE INVENTION

The present invention overcomes the disadvantages and limitations of the prior art by providing a two wheeled trailer that propel itself so as to minimize the pulling effort from the attached bicycle or scooter. The trailer mounts to a bicycle near the rear axle of the bicycle using a three axis connector. The connector may include a quick disconnect feature so that the trailer may be removed easily and quickly. The trailer contains a controller, batteries, and a motor that powers both wheels of the trailer. The trailer is controlled by a force/pressure meter inserted to the attachment arm between the vehicle and the trailer. By reading the meter, the controller is able to adjust the power to the motor, or apply the regenerative brake.

The mounting of the trailer to the vehicle is no different than the existing products: three axis mount attached to the bicycle frame very near the rear wheel. There is no modification needed on the bicycle or scooter at all. That significantly simplifies the users' operation.

The pressure meter provides detail information regarding the push-pull relationship between the trailer and the attached vehicle. If the trailer is pulled, the controller applies power to the motor to propel itself. If the pull force is large, more power will be applied. On the other hand, optionally, if the trailer is pushed back and the wheel is detected rolling forward, the controller applies the regenerative brake to reclaim electric power back to the battery pack. With an extra rotation meter, the trailer can limit its propelling power at a preset safe speed so that the rider will not push the vehicle too fast that may be unsafe with a trailer. These actions are determined dynamically by the on-board controller. The level of power assistance may also be tuned by a dial on the controller module. The power level can be set to high so that the rider feels almost no extra load from the trailer, or to low so that the rider can enjoy more about bearing the family but not as bad as all on him(her)self.

The present invention may therefore comprise a device for propelling a two wheeled trailer comprising: two wheels driven by separate electric motors mounted to a frame; the electric motors in electrical communication with a controller; the controller in electrical communication with at least one battery and in further communication with a force/pressure meter for push-pull reading and in further communication with a dial that sets the power assistant level; a rotation meter attached to at least one of the wheels in communication with the controller; and the device been attached to the vehicle near the rear axle of the vehicle with a connector that allows free rotation.

The present invention may further comprise a two wheeled trailer comprising: two wheels driven by separate electric motors mounted to a collapsible light-weight frame that may carry children or other load; the electric motors in electrical communication with a controller; the controller in electrical communication with at least one battery that may be rechargeable and in further communication with a force/pressure meter for push-pull reading and in further communication with a dial that sets the power assistant level; a rotation meter attached to at least one of the wheels in communication with the controller; and the device been attached to the vehicle near the rear axle of the vehicle with a connector that allows free rotation.

The present invention may further comprise a method of constructing a two wheeled trailer comprising: fabricating a collapsible light-weight frame, the frame having a hitch that allows free rotation incorporating a force/pressure meter; fabricating an assembly with a wheel and driving motor; mounting a wheel-motor assembly on each side of the frame; mounting a rotation meter to one of the wheel; fabricating a controller that is able to read the force/pressure meter, rotation meter information and perform dynamic motor control; mounting at least one battery to the frame; mounting the controller to the frame; connecting the controller to the battery and in further to the force/pressure meter and in further to the motor/wheel assemblies.

The advantages of the present invention are a low cost and efficient device to assist a rider of two wheeled vehicle such as a bicycle or scooter. The dynamic controller has all the intelligence to apply the power to the trailer in a way that the rider can enjoy the riding without worrying the load of the trailer or the control of the powered trailer. Mounting of the trailer is so simple, that is no different from any non-power trailer. The trailer can be fabricated in the same convenient collapsible style as the non-powered version with small extra parts for the power train, which is very friendly to users.

### BRIEF DESCRIPTION OF THE DRAWINGS

In the drawings,

FIG. 1 is a perspective illustration of an embodiment of the present invention attached to a bicycle.

FIG. 2 is a perspective illustration of a top view of the present embodiment of the present invention.

FIG. 3 is a perspective illustration of an embodiment of the present invention showing a detailed view of the attachment mechanism with pressure/force meter inserted.

FIG. 4 is another perspective illustration of an embodiment of the present invention showing a detailed view of the arm-trailer joint with pressure/force meter inserted.

FIG. 5 is another perspective illustration of the present embodiment of the present invention showing the motor and wheel assembly.

FIG. 6 is a perspective illustration of the present embodiment of the present invention shown from the rear showing the controller and battery assembly.

FIG. 7 is a block diagram of the electrical components of an embodiment of the present invention.

### DETAILED DESCRIPTION OF THE INVENTION

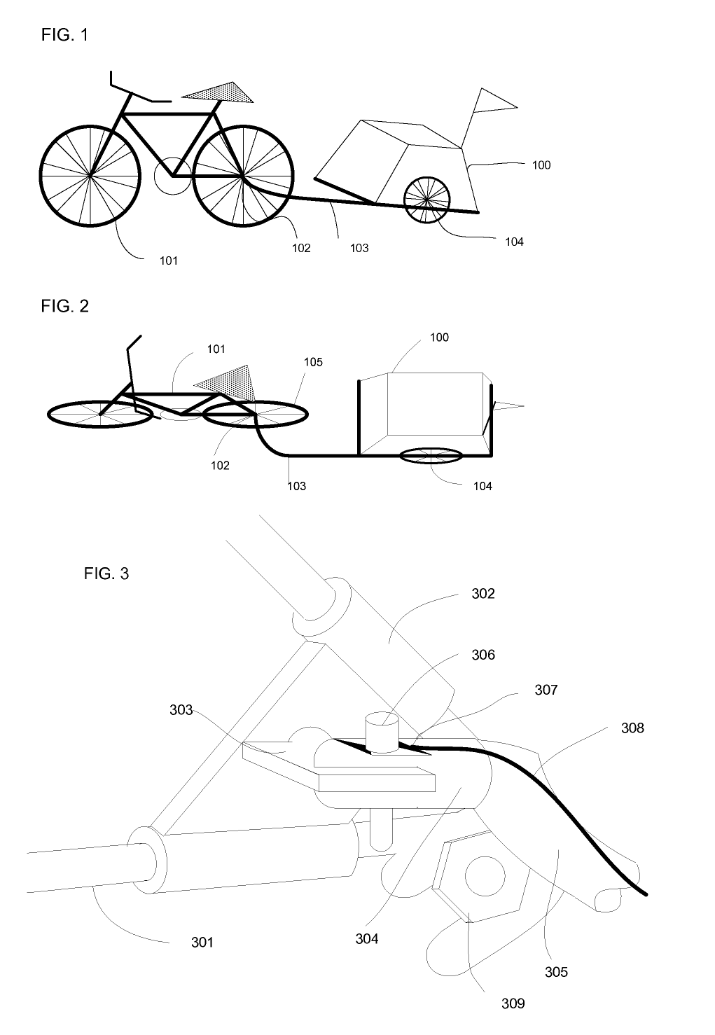

FIG. 1 is a perspective illustration of an embodiment 100 of the present invention attached to a bicycle 101. The embodiment 100 has an arm 103 that attached to the bicycle 101 near the rear axle 102. The attachment mechanism allows free rotation for normal operation. The trailer 100 has two wheels 104 and a body for carrying load such as children or any other kind. The trailer 100 may be folded or collapsed for easy carrying by other vehicles or storage. The bicycle 101 can be any type of bicycle or human powered vehicles. FIG. 2 is the top view of the same perspective illustration of the present invention. The arm 103 is attached to the trailer 100 at one side and has a curve before attaches to the bicycle 101. The curve allows the bicycle 101 making turn without interfering the rear wheel 105 with the arm 103. The result attachment point with the curve is at or close to the center line of the trailer 100. The arm 103 may be removed from the trailer 100 for easy carrying and storage. In such case, some mechanism is required for mounting the arm 103 to the trailer 100.

The embodiment 100 may be an after market part that sold separately from the bicycle 101. In such case, the attachment arm 103 may have a mechanism that attached to the frame of any standard bicycle 101 using clamps or bolt-on hitch on the rear axle 102 or some other type. The mechanism can be quick-release so that the trailer 100 can be easily mounted or dismounted from the bicycle 101.

FIG. 3 is a detail illustration of one design of attachment mechanism that connects the arm 103 to the bicycle 101. The main body 302 is clamped to the bicycle frame 301 close to the rear axle 102. A plate 303 is bolt-mounted on the main body 302 that allows rotating on pitching direction. An example of this type of rotation happens when the bicycle 101 goes over a bump. A clamp 304 is mounted to the plate 303 with an easy removable lock pin 306 secured with hairpin cotter. The clamp 304 is allowed to turn from side to side that is required for the bicycle 101 to make turn. The attachment arm 305 is secured to the clamp 304 by a bolt, which allows the arm to swing. The movement happens when the bicycle 101 leans during a turn. The said attachment mechanism allows free rotation on all directions required for normal bicycle 101 operation.

On the clamp 304, a pair of pressure/force meters 307 are installed on the front and back side of the lock pin 306 where the meters 307 are supported by the body of clamp 304. The top side of the pin 306 has no contact from the clamp 304 directly. Instead, its position is restricted by the pressure/force meters 307. When bicycle 101 is pulling the trailer 100, the momentum of trailer 100 will pull the clamp 304 to the back. Relative to the clamp 304, the pin 306 pushes to the pressure/force meter 307 on the front side of the pin 306. On the other hand, if brake is applied to the bicycle 101, the momentum of trailer 100 pushes the clamp 304 forward. In that case, the pin 306 pushes to the pressure/force meter 307 on the back side of the pin 306. The pressure/force meter result is passed to the controller 605 through a connecting cable 308.

Other embodiments may have different configuration for the attachment mechanism and may have different method to measure the pulling/pushing forces from the bicycle 101 to the trailer 100. Those skilled in the art may be able to implement the present invention in many different ways without violating the spirit or intent of the present invention.

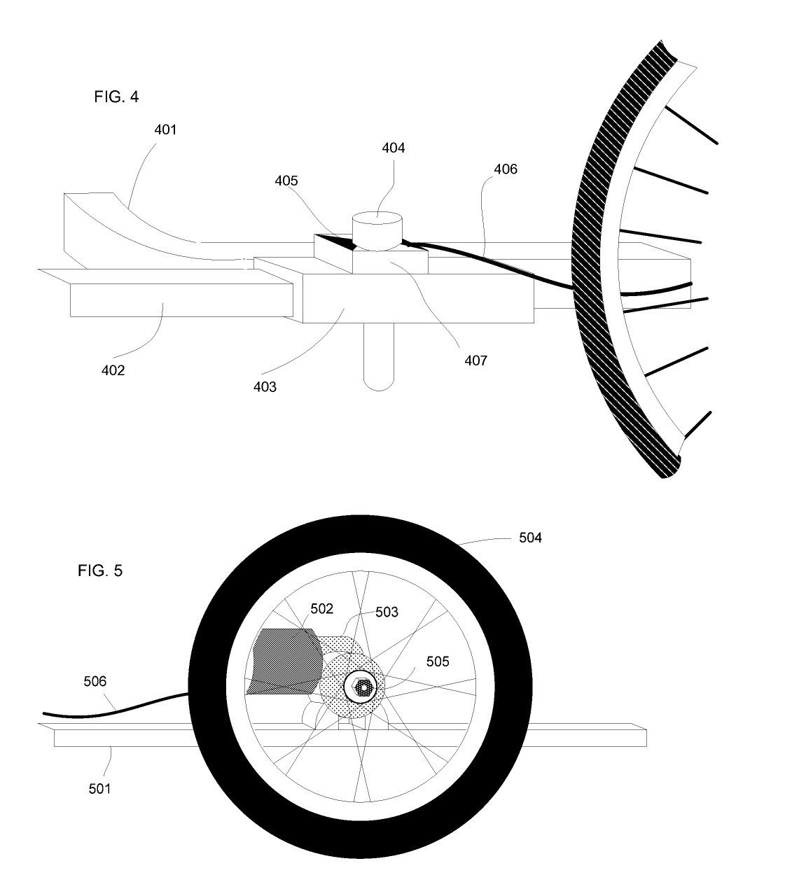

FIG. 4 illustrates another embodiment that incorporates the pressure/force meter in a different location. In the design, the arm 402 is removable from the frame 401 of the trailer 100. The arm 402 is mounted to the frame 401 by a restrainer 403 that is bolted or soldered permanently on the frame 401 and a lock pin 404 secured with hairpin cotter. A pair of pressure/force meters 405 is installed in a housing 407 on the restrainer on the front and back side of the lock pin 404. The top of the lock pin 404 makes no direct contact to the restrainer 403. Instead, its position is restricted by the pressure/force meters 405. When bicycle 101 is pulling the trailer 100, the momentum of trailer 100 will pull the restrainer 403 to the back. Relative to the restrainer 403, the pin 404 pushes to the pressure/force meter 405 on the front side of the pin 404. On the other hand, if brake is applied to the bicycle 101, the momentum of trailer 100 pushes the restrainer 403 forward. In that case, the pin 404 pushes to the pressure/force meter 405 on the back side of the pin 404. The pressure/force meter 405 result is passed to the controller 605 through a connecting cable 406.

In this design, the arm 402 can be easily removed from the frame 401 that reduce the overall size for transportation or storage. To install the arm 402, users simply slide in the arm 402 into the restrainer 403, insert the lock pin 404 and secure with an hairpin cotter. The design also reduce the wiring need from the pressure/force meter 405 to the controller 605 that is mounted on the back of the trailer 100. Other embodiments may have different configuration for the restraining mechanism and may have different method to measure the pulling/pushing forces from the bicycle 101 to the trailer 100. Those skilled in the art may be able to implement the present invention in many different ways without violating the spirit or intent of the present invention.

FIG. 5 illustrates the detail of the embodiment with a motor 502, a gear box 503 mounted on the frame 501 of the trailer 100. The wheel 504 is mounted on the axle of the gear box 503 by a nut 505. The nut 505 can be a quick-release type with lever so that the wheel 504 may be removed from the trailer 100 during transportation or storage. The electric power is delivered to the motor by a cable 506 from the controller 605. The assembly may also include a rotation sensor within the gear box 503.

As illustrated, the motor 502 is aligned orthogonal to the wheel axle. The design reduces the space needed for the motor 502 on the side of the carrying compartment area of the trailer 100. Because the wheel 504 is required to move without electric power applied to the motor 502, the gear box 503 has to be able to be driven from motor 502 or wheel 501. When regenerative break is applied, the motor 502 functions as a generator driven by the wheel 504. The generated electricity is fed to recharge batteries 607 through the controller 605.

Use of enclosed gear box 503 as illustrated reduces the exposed moving parts, which increases the safety for the children carrying device. Nevertheless, alternative embodiments may use chain or belt or other types in place of the gear box 503 that connects motor 502 and wheel 504. The motor may be mounted parallel to the axle of the wheel 504 or in different location. Those skilled in the art may be able to implement the present invention in many different ways without violating the spirit or intent of the present invention.

The gear box 503 may include an electrically controlled clutch that disengage the wheel 504 from the motor 502 completely if no power is applied to the motor 502 or no regenerative brake is applied.

In some embodiments, the wheels 504 may be mounted on suspensions such as coil springs or leaf springs to make the riding more comfortable for the carried children. In such configuration, the motor 502 and the gear box 503 may move tightly with the wheel 504 to eliminate the need for additional Constant Velocity (CV) joint or U-joint axles. Such type of design allows the use of harder tire that decreases friction thus increases the battery life without sacrificing riding comfort.

The embodiment has both wheels 504 driven by separate motors 502. Having two separate motors 502 for each wheel 504 eliminate the disadvantages of just one motor. With one motor, the system can only drive one wheel in a simple configuration and leave the other one free running which causing force imbalance and unnatural twist to the bicycle's 101 frame. Or a common transaxle with differential gear is required to deliver the power to both wheels without locking the wheels during a turn. The cost of the said differential gear system is too high and a transaxle crossing the trailer 100 also make the system design inflexible for highly fashioned consumer product.

With two separate motor 502, the power is delivered to both wheels 504 evenly without the cost of differential gear and the transaxle. Each motor 502 can be located independently, that maximize the design possibility. The motor 502 can run at different speed so that the wheels 504 are not locked during a turn. For some sporty trailer design, the wheel 504 can even installed with an angle expand outward to the ground. The motor 502 can also be smaller in size compare to one-motor design. The smaller motor size is important for trailer 100 carrying children that a safe and comfortable accommodation space is a must. Some room or corner has to be given out to one big motor.

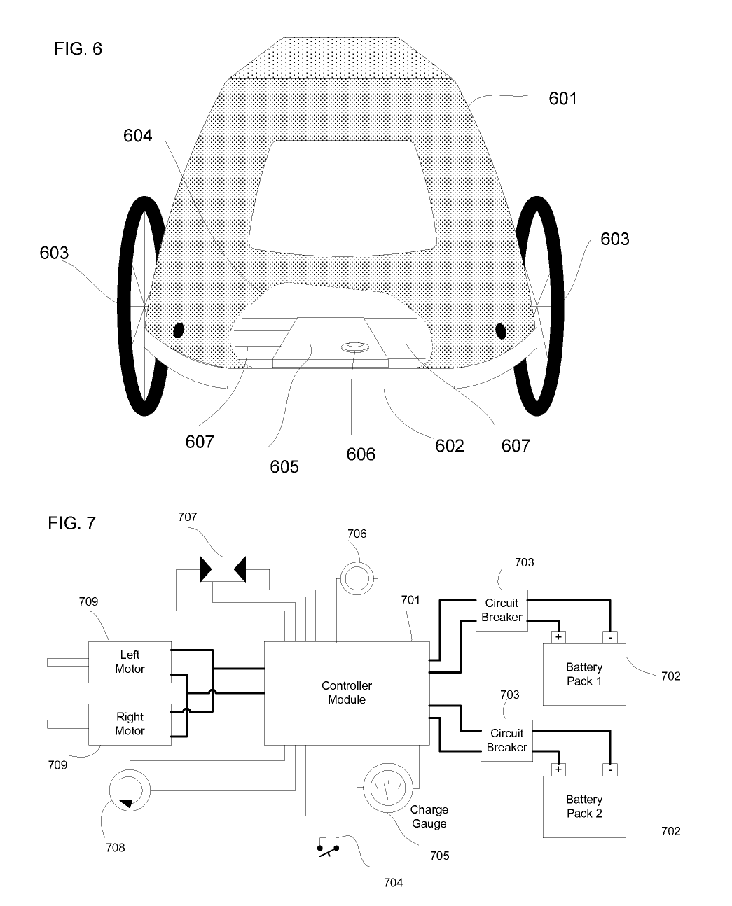

FIG. 6 is another perspective illustration of the embodiment 100 of the present invention, shown from the rear. The trailer 100 is covered by a tent 601 that is made of cloth or other materials on a supporting frame 602. The tent 601 forms the carrying compartment of the embodiment 100. The illustration also shows the two wheels 603 attached on each side of the trailer 100. A conceptual opening 604 on the tent 601 is used to show the detail inside the trailer 100. The controller 605 and battery packs 607 are mounted on the inside back of the trailer 100 that is usually left for storage area. The controller 605 and battery 607 may be removed from the trailer 100 to reduce the operational weight if the function is not needed. It is useful if the trailer 100 can be converted to a stroller. The batteries are separated into two packs 607 on left and right of the controller 605.

The battery packs 607 can be rechargeable or non-rechargeable. The two different types of battery may be used at the same time. Regenerative brake is only available when at least one battery pack 607 is rechargeable. Mixed use of the battery types has benefit to the users. Since all batteries have limited capacity, use only rechargeable battery constrains the operation time of the trailer 100 also requires sufficient charge before each time of use. The present invention can be powered by rechargeable and the non-rechargeable at the same time so that the operator may obtain extra alkaline battery during the trip for extra period of continuous operation. The controller 605 automatically detects the battery type and decides the best use of each battery pack 607.

The charger for the battery pack 607 is not mounted on the trailer 100. In some of prior art, the battery charger is an integrated part of the trailer 100. In that case, the trailer has to be located close enough to the power source for recharging. For the present embodiments, instead of plug-in the trailer 100 to wall electric outlet, user removes the battery pack 607 from the trailer 100 to a separate charger that in turn connects to the wall electric outlet in an easier accessed location while the trailer 100 may be kept in storage. This configuration also allows the user to obtain extra battery packs 607 for extended use. Nevertheless, the depicted configuration does not limit the spirit or intent of the present invention.

A dial 606 is located on top of the controller 605 that is accessible from inside of the trailer 100. The dial 606 controls the power assistance level applied to the motor 502. If low assistance is set, bicycle 101 will spend more effort on pulling the trailer 100 while the battery life can last longer. If high assistance level is set, the user of the bicycle 101 feels almost no load from the trailer 100 although the battery will be depleted faster.

FIG. 7 is the perspective block diagram of the electrical components. The central part is the controller module 701 that have all the components connected. The power is provided from two separate battery packs 702 through two independent circuitries, each with dedicated circuit breaker 703 that disconnect the battery pack 702 from the controller module 701 in case of over drain. The design allows mixed use of different type of battery packs 702 at the same time. Controller 701 decides how to drain current from each battery pack 702 depending on the battery type and the operating condition. The charging capacity of the battery packs 702 is displayed on a gauge 705. The gauge can be a traditional voltmeter or a series of LEDs showing the charge level. The gauge 705 may be located on the handle bar of the bicycle 101 for users reading.

The embodiment may have a main switch 704 that shut off the power completely. The power assistance level is set from a device that may be a potentiometer 706. A pair of pressure/force meter 707 is connected to the controller for the push/poll force measurement. A rotation meter 708 is also connected to the controller that measures the wheel rolling direction and speed. The reading of these two meters forms the major decision making input to the controller. If the wheel is rotating backward or moving with speed lower than an active threshold, no power or braking will be applied. The active threshold is set at a level that prevents the trailer 100 from making jittery move at very low speed. User of the bicycle 101 will have to use his (her) force to tow the trailer 100 at speed below the active threshold. Above the active threshold, the controller 701 applies more power to speed up the motor 709 if the pressure/force meter 707 senses high on pulling force. On the other hand, if the pressure/force meter 707 senses very low on pulling force, or even pushing force, the controller may reduce the power to slow down the motor 709 or apply regenerative brake.

Some embodiments may have an additional switch installed on the handle bar of bicycle 101 that force the regenerative brake on the trailer 100. When user wants to slow down the bicycle, instead of applying brakes on the bicycle 101, he (she) may force the regenerative brake on the trailer 100. More electric power can be reclaimed into the battery pack 702, hence extend the operation distance for the battery pack 702. The said switch may be integrated into the bicycle's 101 brake lever.

The motor 709 in the present embodiment may be a 12V DC motor. Other types of motor, like AC synchronous motor, may be used as well. The size of the motor 709 may vary depending on the designated load and use of the trailer 100. Typically, for carrying one child on a paved road, 200 W combined power is enough for the application. Gear type and ratio also varies depending on the application.

The control mechanism to the motors 709 may be pulse width modulation control, variable reluctance control, phase control or other motion control that can vary the speed of a motor. The optimum configuration depends on the motor type. If synchronous motor is used, separate rotation meter 708 may be omitted since the motor 709 has that function included already.

Unlike previous inventions that are designed for assisting the rider by pushing the bicycles, the present invention is meant to self propel the trailer only at the level to keep up with the leading bicycle. User of the bicycle still has to spend full effort riding the bicycle. The benefit from the present invention is for the user to operate a standard bicycle with a trailer for a leisure trip without spending extra effort to move the trailer. In this type of leisure riding, user does not want any power pushing the bicycle, which defeats the purpose. However, the extra load from the trailer makes it harder for the rider to enjoy the trip. With the present invention, the user may have the most joy from the trip.

The present embodiment is easy to operate. There is no need for any sort of adjustment during riding time, once the assistance level is set. The controller does all the motor power adjustment based on the readings from the pressure/force meter and rotation meter. The basic mechanical structure of the trailer has no difference from the conventional, non-powered version. There is no need to modify the standard bicycle other than installing a hitch device to mount the trailer. The rotation meter reading that can be translated into speedometer and the fuel gauge can be optionally located on the handle bar of the bicycle, which provides extra information to the rider.

The present embodiment also increases the safety of the trailer that carrying children. With the on-board meters, the controller is able to detect certain type of dangers thus applies brake or removes power from the motors accordingly to avoid accident like roll-over from happening.

The present invention provides helpful features for those parents who like to bring their children or people who like to bring their heavy outdoor gear on a recreational ride but hesitate to do so due to the extra effort on pulling the trailer, especially on a hilly area. The ease of operation makes the transition from conventional type easy. The basic structure of the embodiment and the attachment mechanism are very close to the conventional non-powered trailer, which makes the manufacturing also very easy for existing trailer manufacturers.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A trailer attached to a human powered vehicle comprising: each wheel attached to one electric motor; said wheel-motor assembly mounted to a frame; said electrical motor in electrical communication with a controller; said controller in electrical communication with at least one battery and in further communication with a force/pressure meter; said force/pressure meter located in the connector that attached the said trailer to said vehicle; and said trailer being attached to said vehicle near the rear axle of said vehicle with a connector that allows free rotation between said vehicle and said trailer.

2. The trailer of claim 1 wherein said controller comprises regenerative braking; wherein the said battery is rechargeable.

3. The trailer of claim 1 further comprising a switch that forces the said regenerative brake.

4. The trailer of claim 1 further comprising a dial located on the said controller that changes the power assistance level.

5. The trailer of claim 1 wherein the said frame can be collapsed or folded.

6. The device of claim 1 further comprises a rotation meter attached to at least one of the wheels.

7. The trailer of claim 1 wherein the power assistance can be limited to a preset speed for safety purpose.

8. The trailer of claim 1 wherein the said battery and said controller can be removed from the said trailer if not used.
